(19) United States
(12) Patent Application Publication
(10) Pub. No.: US 2016/0206401 A1
(43) Pub. Date: Jul. 21, 2016

(54) ENDODONTIC INSTRUMENT WITH ROUGH SURFACES AND METHOD FOR PRODUCING SUCH AN INSTRUMENT

(71) Applicant: NEOLIX, Chatres-la-Foret (FR)

(72) Inventors: Jacques Pernot, Vieilley (FR); Xavier Rolland, Laval (FR); Hubert Euvard, Besancon (FR)

(21) Appl. No.: 14/914,170

(22) PCT Filed: Aug. 11, 2014
(86) PCT No.: PCT/FR2014/052074

§ 371 Date: Feb. 24, 2016

(30) Foreign Application Priority Data
Aug. 30, 2013 (FR) 1358351

(51) Int. Cl. A61C 5/02; B23P 15/32

(52) U.S. Cl. CPC A61C 5/023; B23P 15/32

(57) ABSTRACT

An endodontic instrument includes a handle to be secured to an instrument holder and an active part to be introduced into a root canal. The active part includes a plurality of faces and at least one edge formed by the intersection of two adjacent faces. At least two of the adjacent faces have a surface with a roughness characterized by an arithmetic mean deviation with respect to the mean line Ra, chosen so that 0.5 μm<Ra<4.5 μm, so that the edge formed by the intersection of said two faces has the profile of an irregular jagged line in the space having at least one deviation greater than 0.5 μm with respect to the mean line.

### 1. CROSS-REFERENCE TO RELATED APPLICATIONS

This application is a Section 371 National Stage Application of International Application No. PCT/FR2014/052074, filed Aug. 11, 2014, the content of which is incorporated herein by reference in its entirety, and published as WO 2015/028743 on Mar. 5, 2015, not in English.

### 2. FIELD OF THE INVENTION

This invention relates to endodontic instruments, enabling a dentist to work on the surface of a root canal, inside of a tooth.

The invention also relates to the production of such endodontic instruments.

### 3. PRIOR ART

Numerous types of endodontic instruments are currently used by dentists. These endodontic instruments are generally fine and relatively flexible, superelastic instruments capable of being inserted by the dentist into the canal of a tooth in order to clean said canal. They may be used manually, or rotated, continuously or alternately, or in translation, or in vibration, or a combination of these movements, by a suitable instrument holder. Such instruments are generally produced by grinding in the prior art, and generally have cutting edges, at the intersection of surfaces formed on the instrument.

In some cases, an endodontic instrument may also have, on its surfaces, striations generated by the wheel, conferring abrasive properties thereon. Such striations are visible in FIG. 3 of the application, showing, with high magnification, an endodontic instrument 3 of the prior art. Said striations form regular lines or scratches on the faces 31 and 32 shown. At the intersection of different faces, the striations lead to the appearance of flashes, which are fragile and risk becoming detached inside the patient's tooth. Said flashes are therefore removed, during production of the tool, by a mechanical treatment such as shot peening or by an electrochemical treatment such as electro-polishing. These treatments have a secondary effect of rounding edges, such as the edge 33 shown in FIG. 3, and therefore of reducing the cutting efficacy of the instrument.

In other cases, the faces of the endodontic instrument are covered with coatings rendering them abrasive. Such a coating is, however, fragile, and easily detaches from the face of the instrument. It then loses its abrasive character, and coating fragments may remain in the patient's tooth.

More commonly, it is sought, by contrast, during production of endodontic instruments, to remove, as much as possible, all roughnesses or irregularities on the faces and edges of the instrument, so as to eliminate breakage areas. This search for perfectly regular edge faces increases the difficulty and cost of production of these instruments. Such endodontic instruments are usually machined by grinding, conferring a smooth and bright aspect on their faces. This smooth aspect is further reinforced when an additional operation of mechanical or electrochemical smoothing is used after machining.

The presence of cutting edges on the endodontic instrument enables work on the inner wall of the root canal. However, such edges have the effect of cutting large chips in the root canal, which may be difficult to remove from said canal. Moreover, this cutting of large chips may generate significant stress on the endodontic instrument, leading to risks of pinching or even breakage of the instrument inside the tooth.

### 4. DESCRIPTION OF THE INVENTION

An aspect of the present disclosure relates to an endodontic instrument including a handle intended to be secured to an instrument holder and an active part intended to be introduced into a root canal, the active part including a plurality of faces, and at least one edge formed by the intersection of two faces; characterized in that at least two of said adjacent faces have a surface with a roughness characterized by an arithmetic mean deviation with respect to the mean line Ra, chosen so that 0.5 μm<Ra<4.5 μm, so that the edge formed by the intersection of said two faces has the profile of an irregular jagged line in the space having at least one deviation greater than 0.5 μm with respect to the mean line.

Thus, the roughness of the faces, at least near the edges, and the resulting irregularity of the edges, enable the instrument to produce smaller chips, which are moreover ground by the rough faces and are therefore more easily removed from the patient's tooth. The cutting forces are moreover reduced by the irregular edges.

Advantageously, the instrument is formed by a nickel and titanium alloy.

Advantageously, said surface of said faces has a plurality of craters conferring said roughness thereon.

Such a conformation enables a roughness to be obtained by generating less fragility in the instrument.

Advantageously, said craters are distributed over said surface in an amount of 50 to 500 craters per mm².

More advantageously, the distribution of craters over said surface is 50 to 100 craters per mm².

This particular density (50 to 100 craters per mm²) and the use of the endodontic instrument in “vibration” mode are particularly suitable and advantageous for blank work.

Also more advantageously, the distribution of craters over said surface is 200 to 300 craters per mm².

This density (200 to 300 craters per mm²) and the use of the endodontic instrument in “continuous rotation” mode are particularly suitable and advantageous for precision and finishing work.

Preferably, said faces have helical shapes, so as to form helical edges.

The disclosure also relates to a method for producing an endodontic instrument as described above, which includes a step of cutting a nickel-titanium alloy bar by a wire electro-erosion method, so as to form a plurality of faces having at least one edge at the intersection of two faces; and a step of cleaning the instrument formed by a chemical method, so as to preserve the roughness of said faces.

Advantageously, said step of cutting by a wire electro-erosion method uses a wire made of brass, brass coated with zinc, molybdenum or tungsten, having a diameter of between 0.02 mm and 0.5 mm.

Preferably, said cutting step uses a dielectric fluid made of deionized water or hydrocarbon.

Preferably, said cleaning step is performed by quenching said instrument in an acid bath subjected to ultrasound.

According to an advantageous embodiment, said instrument is traversed by an electrical current during said cleaning step.

According to another advantageous embodiment, the method includes a heat treatment step conducted separately from the cutting and cleaning steps, the heat treatment step consisting in exposing the endodontic instrument during production to temperatures of 300 to 600 degrees Celsius for between 10 minutes and 5 hours, with the addition of the time necessary for returning to room temperature, suddenly, quickly or slowly (between several seconds and several hours). This heat exposure is preferably performed by keeping the instruments in an oven, in an environment capable of being altered, for example air, inert gas (nitrogen, argon), under vacuum. The heat exposure may alternatively be performed by submerging the endodontic instruments into a liquid, for example a nitrate salt bath.

### 5. LIST OF FIGURES

The invention will be easier to understand in view of the following description of a preferred embodiment, provided for illustrative and non-limiting purposes, and accompanied by figures, wherein:

FIG. 1 is a view of an endodontic instrument according to a possible embodiment of the invention;

FIG. 2 is a view with high magnification of a portion of the endodontic instrument of FIG. 1;

FIG. 3, which has been mentioned above, is a view with high magnification of a portion of an endodontic instrument of the prior art.

### 6. DETAILED DESCRIPTION OF AN EMBODIMENT

6.1 Endodontic Instruments

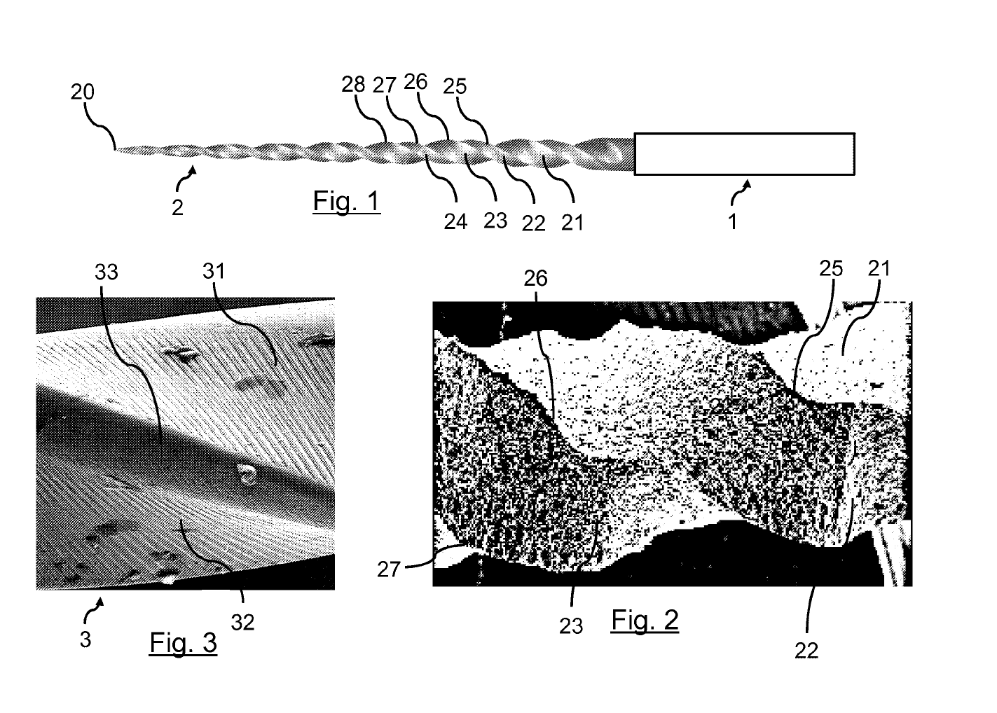

FIG. 1 shows an endodontic instrument according to an embodiment of the invention. This endodontic instrument has a handle 1, intended to be inserted into instrument-holding equipment, and an active part 2 intended to work on the surface of a root canal. The active part has a plurality of faces—in the case shown, four faces 21, 22, 23 and 24, which are wound helically from the handle 1 to the tip 20 of the instrument. At the intersections of said faces, edges 25, 26, 27 and 28 form the cutting portions of the endodontic instrument, which enable it to work on the surface of the root canal. The angles between the faces, forming the edges, are between 40° and 160°.

6.2 Rough Surface

FIG. 2 is a detail view of a portion of the active part 2 of the endodontic instrument. As shown in this figure, the surfaces of each of the faces of the endodontic instrument are not planar, but have irregularities rendering said faces rough. These irregularities are formed by a multitude of craters, of variable depth, conferring a roughness on the surface characterized by an arithmetic mean deviation with respect to the mean line (statistical criterion Ra) of between 0.5 and 4.5 μm. These craters are distributed in an amount of 50 to 500 craters per mm². Such irregularities are not regular striations or lines machined on the tool but recesses and embossments of random and irregular dimensions, conferring on the surface an aspect similar to that of a ceramic.

According to the size of the instrument, the roughness and crater density may be adjusted. For example:
an instrument having a tip diameter of 0.10 mm has a roughness of between 0.5 and 1 μm and a density of 300 to 400 craters per mm²;
an instrument having a tip diameter of 0.40 mm has a roughness of between 3 and 4.5 μm and a density of 300 to 400 craters per mm².

The roughness of the different faces of the instrument (roughness may vary from one face to another) naturally confers abrasive characteristics on said faces. As this roughness is part of the instrument, and not part of an external coating, it is particularly robust and does not present a risk of separation of particles that may become lost in the patient's tooth.

The endodontic instrument provided with a roughness according to the invention is particularly advantageous because it makes it possible to leave the machined surface of the dentin with its natural granulometry, while a classic instrument of the prior art (rounded edge) compresses the machined surface (production of smear layer).

The machined surface with its natural granulometry confers advantages, including at least:
better adhesion during placement of a reinforcing post (non-smooth aspect of the etching surface);
a better environment for natural restoration of the canal.

6.3 Discontinuous Edges

As each of the faces forming the active part 2 has an irregular surface, the edges 25, 26, 27 and 28 formed by the intersection of said faces also have an irregular uneven shape. As shown in FIG. 2, each of these edges thus has the profile of a jagged (irregular uneven) line. This line may thus have portions with a deviation with respect to the mean line capable of reaching a maximum of between 0.5 and 5.0 μm. These deviations with respect to the mean line may be in any direction, randomly.

6.4 Effect on Cutting Forces

Thus, when the endodontic instrument 1 is used, the cutting lines of said edges form series of small contiguous edges, angles and shapes which are variable. Such edges give the instrument an enhanced cutting quality, radially and axially. They in fact have the effect of irregular saw teeth, which have the effect of reducing cutting forces. Thus, the endodontic instrument is subjected to less significant cutting forces, the root of the patient's tooth is subjected to less significant forces causing less stress, and the risk of breakage of the instrument and fracturing of the root of the tooth are reduced.

6.5 Effects on Chips

The edges of discontinuous and irregular shape generate, during use, the production of small debris. In fact, such edges have the effect of fragmenting, or chipping, the dentin, forming small chips, or debris, rather than the large chips produced by the smooth edges of the endodontic instruments of the prior art.

Moreover, the different faces of the instrument have a tendency, owing to their high roughness, to better guide the debris, which is thus better removed. In addition, when said debris is held between one of the faces of the instrument and the surface of the root canal, the abrasive surfaces scrapes it and reduces it to powder. The chips are thus replaced by a powdery mixture that may easily be removed from the root canal. The risks of obstruction of the canal by large chips, or blockage of the instrument by said chips, are thus significantly reduced.

6.6 Production Method

To obtain an endodontic instrument according to the invention, in which the faces have irregularities rendering said faces rough and the edges irregular, it is possible to implement a method of machining by wire electro-erosion. Such a method consists in avulsing the material with a plurality of electric arcs, thus forming craters at the surface of the machined parts and conferring a rough aspect thereon. Wire electro-erosion machining is a technique involving fusion, vaporization and ejection of material. The energy is provided by electrical discharges passing between two electrodes, the part to be machined, and the cutting (or machining) wire. Electro-erosion machining is known for generating roughnesses on the order of 0.4 to 30 μm.

To produce an endodontic instrument according to the invention, the wire electro-erosion machining method may be implemented using a cutting wire capable of being, for example, brass, brass coated with zinc, molybdenum or tungsten, having a diameter of between 0.02 mm and 0.5 mm. The dielectric fluid may be deionized water or hydrocarbon. The machining may be based on a nickel-titanium alloy bar or tube, the cross-section of which may have a variable shape (typically round or square) and generally having a diameter or a side between 0.1 mm and 3 mm.

The electro-erosion machining method implemented in order to produce an endodontic instrument according to the invention is suitable for producing specifically a roughness characterized by an arithmetic mean deviation with respect to the mean line (statistical criterion Ra) between 0.5 and 4.5 μm.

To do this, in order to obtain an effective and controlled energy concentration, the diameter of the cutting wire (around 0.1 mm) is associated with the thickness of the cut of each part (around 0.1 mm) so as to enable the scanning of s surface state quality panel. Moreover, the machining of parts is performed on the bar so as to provide a space of 10 to 100 mm between each part so as to find the relationship between the cutting wire/thickness of the cut part, by contrast with parts bonded to one another, as commonly applied in wire electro-erosion according to the prior art.

The craters generating the roughness of the faces of the instrument are caused by electric arcs between the machining wire and the instrument, through an electrically insulating dielectric fluid. After said machining step, the instrument is subjected to a surface cleaning, making it possible to specifically remove the superficial layer having a thickness of 1 to 30 μm generated by the cutting of the material and the residue of the machining wire. This treatment, however, has no face polishing effect, and does not alter the edges of the endodontic instrument.

This cleaning step is performed chemically in an acid bath with ultrasound, in the presence or absence of an electric current (chemical or electrochemical treatment).

The method for producing an endodontic instrument according to the invention also includes a heat treatment step conducted separately from the cutting and cleaning steps. This heat treatment step is in particular performed independently, without intervention on the endodontic instrument during the heat treatment. This step consists in exposing the endodontic tool during production, before or after the surface-cleaning step, to temperatures of 300 to 600 degrees Celsius for between 10 minutes and 5 hours. This particular heat treatment makes it possible to suppress, or, at the very least, to limit, elasticity, to increase ductility and thus increase the fatigue strength of the endodontic tool while preserving a high superficial hardness of the edges and faces, thus preserving good cutting and wear resistance characteristics.

During cutting of the wire, the machined material is fused, causing a superficial heating of the part. This causes a superficial change in structure (martensite). The superficial hardness is then slightly increased during this transformation, but internal stresses are produced. The material at this stage is in the super-elastic phase. By applying the heat treatment described above after electro-erosion wire cutting, the internal tension is released, the material is homogenized and stabilized, while very slightly reducing the superficial hardness (by several Hv). The material is therefore in a phase with very limited elastic effects and with a preserved hardness of around 260 Hv: ductile material, resistant to fatigue.

The cutting of nickel-titanium endodontic instruments by a wire electro-erosion method followed by a heat treatment performed under certain conditions thus makes it possible to associate good characteristics of cutting, wear resistance and fatigue strength.

An exemplary embodiment of the present disclosure overcomes the disadvantages of the prior art.

An exemplary embodiment provides an endodontic instrument enabling work on the surface of the root canal by generating a weaker cutting force than the instruments of the prior art and, by limiting the screwing effect, enables reduced risk of wedging or breakage of the endodontic instrument in the patient's tooth.

An exemplary embodiment provides such an endodontic instrument that generates the production of smaller chips, and that enables easy removal of said chips.

An exemplary embodiment provides such an instrument that has reinforced abrasive properties.

Finally, an exemplary embodiment provides an effective method for producing such endodontic instruments that may be implemented more easily than the production methods of the prior art, and that are less expensive.

Although the present disclosure has been described with reference to one or more examples, workers skilled in the art will recognize that changes may be made in form and detail without departing from the scope of the disclosure and/or the appended claims.

1. An endodontic instrument comprising:
a handle configured to be secured to an instrument holder; and
an active part configured to be introduced into a root canal;
wherein the active part includes a plurality of faces, and at least one edge formed by the intersection of two adjacent faces;
wherein said adjacent faces of the at least one edge have a surface with a roughness characterized by an arithmetic mean deviation with respect to the mean line Ra, chosen so that 0.5 μm<Ra<4.5 μm, so that the edge formed by the intersection of said two adjacent faces has a profile of an irregular jagged line in a space having at least one deviation with respect to the mean line greater than 0.5 μm,
wherein said surface of said adjacent faces having a plurality of craters conferring said roughness thereon, and
wherein said craters are distributed over said surface in an amount of 50 to 500 craters per mm².

2. The endodontic instrument according to claim 1, wherein the active part is formed by a nickel and titanium alloy.

3. The endodontic instrument according to claim 1, wherein said faces have helical shapes, so as to form helical edges.

4. A method for producing an endodontic instrument, comprising:
cutting a nickel-titanium alloy bar by a wire electro-erosion method, so as to form a plurality of faces forming an active part configured to be introduced into a root canal, the active part comprising at least one edge at the intersection of two adjacent faces,
wherein said adjacent faces of the at least one edge have a surface with a roughness characterized by an arithmetic mean deviation with respect to the mean line Ra, chosen so that 0.5 μm<Ra<4.5 μm, so that the edge formed by the intersection of said two adjacent faces has a profile of an irregular jagged line in a space having at least one deviation with respect to the mean line greater than 0.5 μm,
wherein said surface of said adjacent faces having a plurality of craters conferring said roughness thereon, and
wherein said craters are distributed over said surface in an amount of 50 to 500 craters per mm²; and
cleaning the instrument formed by a chemical method, so as to preserve the roughness of said adjacent faces.

5. The method for producing an endodontic instrument according to claim 4, wherein the cutting by a wire electro-erosion method uses a wire made of brass, brass coated with zinc, molybdenum or tungsten, having a diameter of between 0.02 mm and 0.5 mm.

6. The method for producing an endodontic instrument according to claim 4, wherein the cutting uses a dielectric fluid made of deionized water or hydrocarbon.

7. The method for producing an endodontic instrument according to claim 4, wherein the cleaning is performed by quenching said instrument in an acid bath subjected to ultrasound.

8. The method for producing an endodontic instrument according to claim 4, wherein said instrument is traversed by an electrical current during said cleaning step.

9. The method for producing an endodontic instrument according to claim 4, wherein the method includes a heat treatment conducted separately from the cutting and cleaning, the heat treatment consisting in exposing the endodontic instrument to temperatures of 300 to 600 degrees Celsius for between 10 minutes and 5 hours.
